(19) United States
(12) Patent Application Publication
(10) Pub. No.: US 2003/0200715 A1
(43) Pub. Date: Oct. 30, 2003

(54) Corrosion resistant window shutter

(76) Inventors: Grover M. Blackwell, Awendaw, SC (US); Harry Rembert, Summerton, SC (US)

Correspondence Address: B. Craig Killough, Barnwell Whaley Patterson & Helms, LLC, Suite 300, 134 Meeting Street, Charleston, SC, 29401, US

(21) Appl. No.: 10/134,353

(22) Filed: Apr. 27, 2002

(51) Int. Cl. E06B 7/08

(52) U.S. Cl. 52/473

(57) ABSTRACT

A window shutter has corrosion resistant stiles with a non-metallic core and louvers, and non-metallic top and bottom rails. The shutter is resistant to the adverse effects of sunlight, humidity, rain and wind, and will retard flying objects, and will pass commonly used missile tests for building materials. The resulting shutter will also withstand substantial stresses from wind loads, so as to perform satisfactorily in wind load tests. The window covering of the invention is substantially maintenance free.

### FIELD OF THE INVENTION

This invention relates to window shutters.

### BACKGROUND OF THE INVENTION

Exterior window coverings, such as window shutters, have been used for many years. Window shutters are positioned over glass windowpanes to protect the glass windowpanes from flying objects that can damage, or break, the glass, and enter the building. Window shutters may be used to secure a building against break-ins, and may be used to block sunlight from entering the building through the windowpane. The window covering, or shutter, may be pivoted away from the windowpane to lie flat against the building. When the shutter is pivoted away from the windowpane, it enhances the beauty and appearance of the building. Alternatively, the window shutter may be purely decorative.

There is a need to provide a window shutter that will pass missile tests that have been established by testing agencies to judge a material's ability to withstand and retard flying objects. The window shutter should also be able to perform successfully in commonly used wind load tests, which judge a material's ability to withstand stresses from continuous wind loads.

There is also a need for an window shutter that will not require substantial maintenance in adverse conditions. In particular, there is a need for a window shutter which will remain relatively maintenance free in hostile environmental conditions, such as the tropics and subtropics, where direct sunlight exposes the window covering to substantial heat, humidity, and ultraviolet rays from the sun. Further, these environments are typically near salt water, and the salt air contributes to the deterioration of building materials. Still further, these tropical and subtropical environments may experience frequent hurricanes, which means that the substantially maintenance free window covering is exposed to high winds and wind driven water.

### SUMMARY OF THE INVENTION

The present invention is a window shutter that is comprised of a corrosion resistant stile and non-metallic core and louvers. The device is resistant to the adverse effects of sunlight, humidity, rain and wind, and will retard flying objects, and will pass a missile test. The resulting shutter will also withstand substantial stresses from wind loads, so as to perform satisfactorily in wind load tests. The window covering of the invention is substantially maintenance free.

### DESCRIPTION OF THE DRAWINGS

FIG. 1 is a perspective view of the window shutter of the present invention.

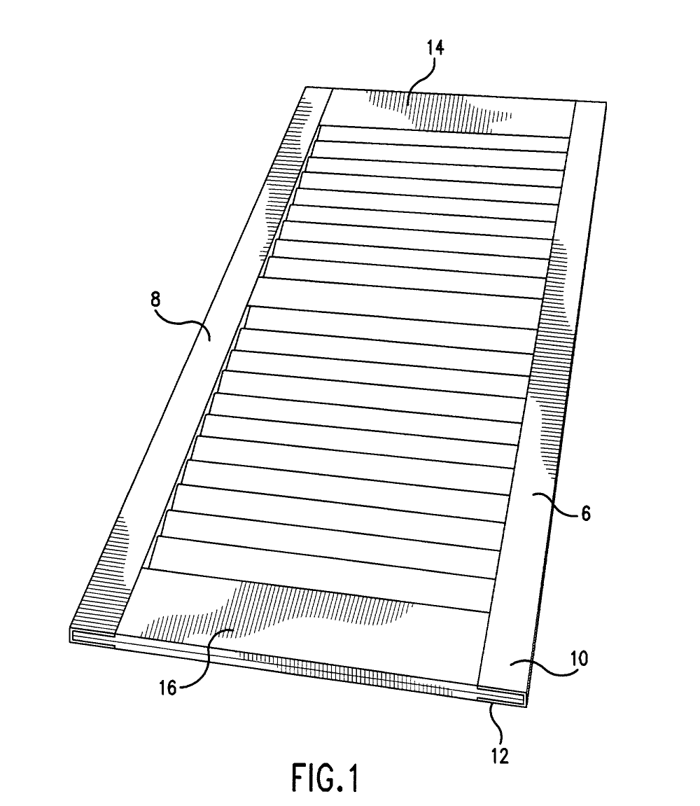

FIG. 2 is a partial view of the window shutter, with some of the louvers removed from the slots in the core.

FIG. 3 is a partial view of the top of the window shutter.

### DETAILED DESCRIPTION OF THE INVENTION

The window shutter of the preferred embodiment has a pair of stiles 6, 8 attached along each of the parallel sides of the shutter that represent the vertical length of the shutter. The stile is preferred to be generally U-shaped, and comprised of three sides. The stile is formed of a rigid corrosion resistant material, and is preferred to be a metal, such as aluminum. A first side 10 of the stile is generally parallel to a second side 12 of the stile.

A first vertical core 2 is positioned within stile 6, and a second vertical core is positioned within stile 8. The first core and the second core are positioned generally vertically, and are contained within their corresponding stiles. A top rail 14 extends generally horizontally between the stiles 6,8 and a bottom rail 16 extends generally horizontally between the stiles. The cores and rails may be formed of multiple layers of material, or a single layer of material. In the preferred embodiment, the core and rails are formed of polyvinyl chloride (PVC).

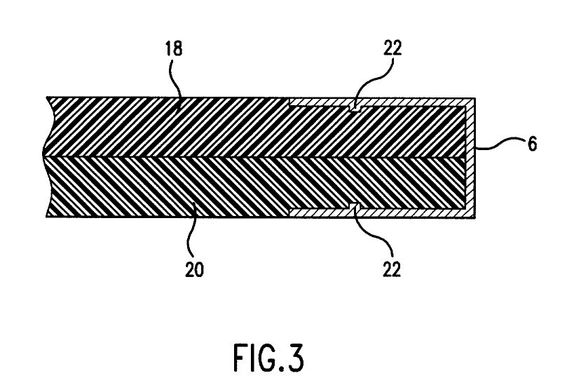

The top rail as shown in FIG. 3 may be formed of two layers of material 18, 20, which may be glued together using cement that is appropriate for PVC. The bottom rail may be similarly formed. The top and bottom rails may be of a reduced dimension on a portion of the outer surface thereof so as to engage the stiles, while maintaining a constant thickness for the perimeter of the shutter when measured at the center of the top and bottom rails and at the stiles.

Alternatively, the top rail may engage a void formed in the each of the vertical rails for receiving the top rail, rather than engaging the stile directly. The bottom rail may similarly engage a void formed in a lower portion of the vertical cores. The rails may be glued within the voids with an appropriate cement.

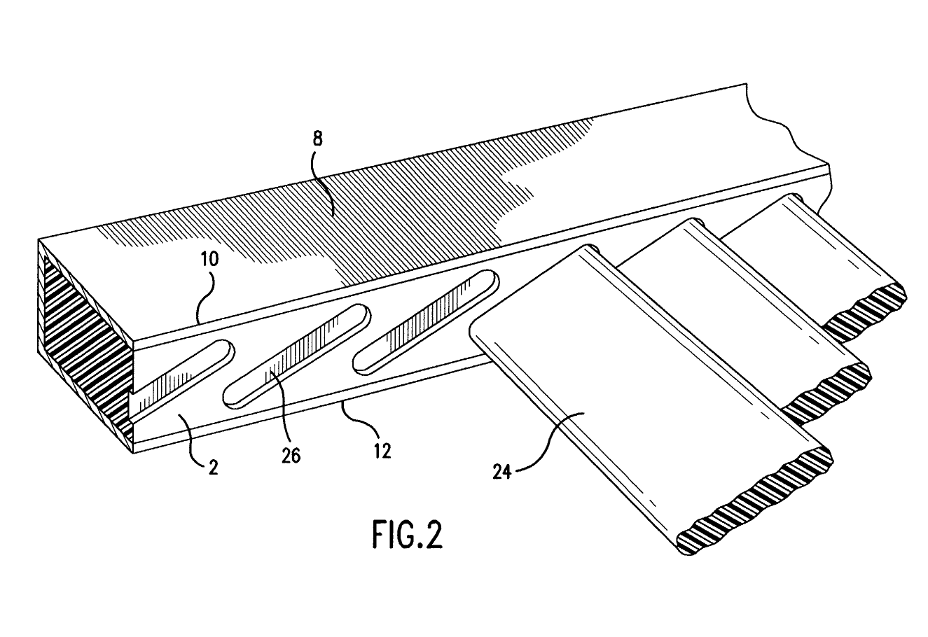

As shown in FIG. 2, the vertical cores that engage the stiles have a plurality of grooves 16 that are formed generally parallel to each other, and on a desired angle. Each groove of each vertical core corresponds to a groove in the opposite vertical core. Louvers 24 are mounted in each pair of corresponding grooves, so that the void that is present between the top rail, the bottom rail and the vertical cores is covered with the louvers, as shown in the drawing figures.

In the preferred embodiment, the cores have a rectangular cross section, so that the core has four sides. Three of the sides engage, and are entirely surrounded by the three sided, or U-shaped, stile. The fourth side comprises the plurality of grooves into which the louvers are inserted.

The stiles may have one or more tongues 22 that fit into grooves that are formed in the rails, and/or in the cores.

The combination of a corrosion resistant metal, such as aluminum, with the core, rails and louvers formed of PVC results in a window shutter that is corrosion resistant and may be used in salt air and other hostile environments with minimal maintenance. The resulting shutter is surprisingly resistant to wind propelled missiles, and will withstand hurricane level wind forces and wind driven water when constructed to dimensions that are normal for wooden shutters.

The core and rails may be formed in varying materials as desired, such as white, dark green, or black, or any other color desired. Alternatively, the shutter may be painted to any color desired.

The shutters are attached to a building, or to a window frame. The shutters may be attached by pivotal means, such as hinges, so that the shutter may be positioned over a window, or away from a window, as desired.

What is claimed is:

1. A window covering for exterior use, comprising;
a. a first stile comprising a first side and a second side, wherein said first side of said first stile is generally parallel to said second side of said first stile, and wherein an opening is formed in said first stile between said first side and said second side;
b. a second stile comprising a first side and a second side, wherein said first side of said second stile is generally parallel to said second side of said second stile, wherein an opening is formed in said second stile between said first side and said second side, and wherein said first stile is generally parallel to said second stile;
c. a first core that is positioned between said first side of said first stile and said second side of said first stile, said first stile having a plurality of generally parallel grooves formed therein;
d. a second core that is positioned between said first side of said second stile and said second side of said second stile, said second stile having a plurality of generally parallel grooves formed therein that face said plurality of generally parallel grooves formed in said first core; and
e. a plurality of louvers that connect said first core and said second core by engaging said plurality of generally parallel grooves formed in said first core and by engaging said plurality of generally parallel grooves formed in said second core.

2. A window covering for exterior use as described in claim 1, further comprising a rail that engages said first core and said second core and is positioned above said louvers.

3. A window covering for exterior use as described in claim 2, further comprising a rail that engages said first stile and said second stile and is positioned above said louvers.

4. A window covering for exterior use as described in claim 1, further comprising a rail that engages said first core and said second core and is positioned below said louvers.

5. A window covering for exterior use as described in claim 2, further comprising a rail that engages said first stile and said second stile and is positioned below said louvers.

6. A window covering for exterior use as described in claim 3, further comprising a rail that engages said first core and said second core and is positioned below said louvers.

7. A window covering for exterior use as described in claim 4, further comprising a rail that engages said first stile and said second stile and is positioned below said louvers.

8. A window covering for exterior use as described in claim 1, wherein said first stile further comprises a third side that connects said first side to said second side, and wherein said stile is generally U shaped.

9. A window covering for exterior use as described in claim 1, wherein said first stile is formed of metal.

10. A window covering for exterior use as described in claim 9, wherein said metal is aluminum.

11. A window covering for exterior use as described in claim 1, wherein said first core is formed of polyvinyl chloride.
